(19) United States
(12) Patent Application Publication
(10) Pub. No.: US 2012/0163545 A1
(43) Pub. Date: Jun. 28, 2012

(54) SWITCHING DEVICE FOR AN X-RAY GENERATOR

(75) Inventor: Norbert Eydeler, Schleswig-Holstein (DE)

(73) Assignee: KONINKLIJKE PHILIPS ELECTRONICS N.V., EINDHOVEN (NL)

(21) Appl. No.: 13/386,828

(22) PCT Filed: Sep. 2, 2010
(86) PCT No.: PCT/IB2010/053948

§ 371 Date: Jan. 24, 2012

(30) Foreign Application Priority Data
Sep. 8, 2009 (EP) 09169734.2

(51) Int. Cl. H05G 1/12

(52) U.S. Cl. 378/107

(57) ABSTRACT

The invention relates to a switching device for an X-ray generator for providing a required output power voltage at an output of a resonance power converter. The switching device may comprise a main switch 16 and an auxiliary switch 26, wherein the main switch 16 may comprise a first internal capacitance 5 and wherein the auxiliary switch 26 may be connected in parallel to the main switch 16. Moreover, the main switch 16 may be controllable and the auxiliary switch 26 may be also controllable. Furthermore, the auxiliary switch 26 may be controllable in dependence of the main switch 16, wherein the auxiliary switch 26 may be controllable for discharging of the first internal capacitance 5 of the main switch 16.

### BACKGROUND OF THE INVENTION

Radiation generators, especially X-ray generators, may comprise a resonant inverter which may operate at high switching frequencies, for example at 100 kHz (kilo Hertz) or higher. These switching frequencies may result in increased switching losses.

In resonance inverters a plurality of switches may be utilized, for example several MOSFETs. These MOSFETs may be connected in parallel to each other and their parasitic output capacities may be added up due to the parallel connections. The parasitic output capacitance may be inverse proportional to a rail voltage of the generator, which output capacitance may be especially large for zero voltage switching (ZVS).

It is a disadvantage that parasitic oscillations may occur between a drain of a MOSFET and a gate of a MOSFET, when being switched on. These parasitic oscillations may occur between one MOSFET in one part of a circuit bridge and another MOSFET in another part of a circuit bridge. Moreover, parasitic inductances may be present. The generated parasitic oscillations may produce high losses which may limit the safe operation of a resonant inverter.

### SUMMARY OF THE INVENTION

It is an object of the invention to provide a switching device for an X-ray generator and a method for controlling a switching device for an X-ray generator which may reduce the oscillation phenomena caused by switching at the output of a resonant power converter.

The object of the invention is solved by the subject-matter of the independent claims and advantageous embodiments are incorporated in the independent claims.

According to an exemplary embodiment of the invention, there is provided a switching device for an X-ray generator for providing a required output power voltage at an output of a resonance power converter. The switching device may comprise a main switch and an auxiliary switch, wherein the main switch may comprise a first internal capacitance and wherein the auxiliary switch may be connected in parallel to the main switch. Moreover, the main switch may be controllable and the auxiliary switch may be also controllable. Furthermore, the auxiliary switch may be controllable in dependence of the main switch, wherein the auxiliary switch may be controllable for discharging of the first internal capacitance of the main switch.

With the suggested electrical circuit the main switch may be switched on with reduced switching losses. It is provided a smooth or soft switching of the main switch. Parasitic oscillations may be reduced during switching.

One method to reduce switching losses may be zero current switching (ZCS), which may be a soft switching method. A resonance inverter may operate in a zero voltage switching (ZVS) mode in combination with a quasi-resonance zero switching (ZCS) mode. In this switching mode the resonant current through a load may be monitored and an appropriate switching point may be estimated using a phase-shift device (PD-transfer function). At a predetermined switching time a switch, such as a MOSFET, may be switched and accommodation process from one power level to another power level may be performed. Conditions of zero current switching (ZCS) are explained for example in WO 2006/114719 A1.

The main switch may comprise an output capacitance, which may be a parasitic capacitance and which may be an output capacitance of the first main switch.

According to an exemplary embodiment of the invention, the auxiliary switch may be operable in synchronization with the main switch.

An synchronization may be provided in relation to switching on and/or switching off of the main switch and the auxiliary switch.

According to an exemplary embodiment of the invention, the main switch may comprise a first MOSFET.

The MOSFET is a semiconductor and may be of a CFD-type MOSFET, for example of the series of CoolMOS™ power transistors of the company Infineon. The MOSFET may have an output voltage of about 50 V (volt). A MOSFET may switch within a shorter time than other semiconductors, for example IGBTs.

According to an exemplary embodiment, the auxiliary switch may comprise a second MOSFET.

It may be foreseen that the first MOSFET and the second MOSFET are not identical in their electrical and thermal behaviour. The second MOSFET may comprise a different R_{ds}on, which may be a bulk resistance or a path resistance of a MOSFET. The second MOSFET and the first MOSFET may be of the same voltage class, for example of 600 V (volt). Moreover, the first MOSFET and the second MOSFET may be located in separate housings.

According to an exemplary embodiment, a first drain connection of the first MOSFET may be connected with a second drain connection of the second MOSFET and a first source connection of the first MOSFET may be connected with a second source connection of the second MOSFET.

A MOSFET may comprise a source connection, a drain connection and a gain connection. The first MOSFET and the second MOSFET may be connected in parallel to each other. A circuit with a plurality of MOSFETs may provide a higher output current compared to one single MOSFET.

According to an exemplary embodiment of the invention, the auxiliary switch may be adapted to carry the full current of the main switch.

The full current of the main switch may be the output current of the main switch when being switched on. The output current may be the resonant current of the switching device. At a first time the full resonant current of the main switch may be carried by the main switch and at a second time the same full resonant current of the main switch may be carried by the auxiliary switch at least for a short period of time, for example some milli seconds. There may be provided a commutation or a switch over of the current or resonant current from the main switch to the auxiliary switch.

According to an exemplary embodiment of the invention, the main switch may comprise a first R_{ds}on and the auxiliary switch may comprise a second R_{ds}on, wherein the first R_{ds}on may be smaller than the second R_{ds}on.

An R_{ds}on is a bulk resistance or a path resistance between the drain and the source of a semiconductor. The main switch may be a first semiconductor and the auxiliary switch may be a second semiconductor. A path resistance may depend on the dimensions and the topography of the semiconductor.

According to an exemplary embodiment of the invention, the main switch may comprise a first internal capacitance and the auxiliary switch may comprise a second internal capacitance. Moreover, the second internal capacitance may be smaller than the first internal capacitance.

An internal capacitance may be a parasitic capacitance which may be present in a real electrical component.

According to an exemplary embodiment of the invention, the main switch may comprise an n-type-MOSFET.

An n-type MOSFET may have smaller switching losses compared to a p-type MOSFET. Moreover, the auxiliary switch may also comprise an n-type MOSFET.

According to an exemplary embodiment of the invention, the main switch may be connected in parallel to a switching capacitance.

A switching capacitance or a snubber capacitance as an electrical component may provide a stabilization of the output voltage of the main switch.

According to an exemplary embodiment of the invention, there may be provided a resonant inverter, which may comprise a switching device as described above.

A resonant inverter may comprise a first half bridge of semiconductors. It may also be foreseen that a resonant inverter may comprise a first half bridge of semiconductors and a second half bridge of semiconductors. Thus, the resonant inverter may comprise a full bridge. A resonant inverter may comprise resonant components, such as a capacitor and/or an inductance. The capacitor and the inductance may be connected in series and/or in parallel to each other in order to provide a resonant current for the output of the resonant inverter. A resonant inverter may be utilized for generating and supplying power for an x-ray generator, especially for a high voltage generator of an x-ray apparatus.

According to an exemplary embodiment of the invention, there may be provided a method for controlling a switching device for an X-ray generator in order to provide a required output power voltage at an output of a resonant power converter. The method may comprise controlling a main switch, controlling an auxiliary switch and discharging the main switch by discharging a first internal capacitance of the main switch with the auxiliary switch.

According to an exemplary embodiment, the method may comprise controlling of the main switch and controlling of the auxiliary switch comprising closing or switching on the auxiliary switch in synchronization with closing or switching on the main switch.

According to an exemplary embodiment, the method may further comprise switching on the main switch during the auxiliary switch is switched on within an overlapping time.

The auxiliary switch may be closed synchronized in relation to a switch-on process of the main switch. For a short time period the auxiliary switch may carry the full resonant current and at the same time the auxiliary switch may discharge the output capacitance or the first internal capacitance of the main switch which may comprise a high R_{ds}on. The commutation process and especially the discharge of the switching capacitance of the main switch may be performed in a controlled manner. This may result in a suppression of the parasitic oscillations.

According to an exemplary embodiment the overlapping time may has substantially a time duration of about 10 ns to about 100 ns (nano seconds).

The time duration for loading may depend on the R_{ds}on of the auxiliary switch as well as on a parasitic capacitance of the semiconductors of the main switch. The main switch may operate for example at a voltage of 50 V. The loading time may be the time until an output voltage of the main switch reaches a predetermined voltage level for operation purpose of the resonant converter, for example increasing the voltage from zero volt to 50 V.

The auxiliary switch may be an additional low power switch, for example a MOSFET, connected in parallel to the main switch, for example an other MOSFET. The auxiliary switch may be operated in synchronization with the main switch. For a small duration of time the auxiliary switch may carry a full resonance current and at the same time the auxiliary switch may discharge the output capacitance of the main switch with a relatively high R_{ds}on. Thus, the commutation process and especially the discharge of the capacitance associated with one or a plurality of main switches may be performed in a controlled manner. This may result in a suppression of the parasitic oscillations of an x-ray generator.

### BRIEF DESCRIPTION OF THE DRAWINGS

The following figures illustrate some exemplary embodiments, wherein

FIG. 1 shows a an exemplary embodiment of a circuit of a MOSFET,

FIG. 2 shows an exemplary embodiment of a half bridge of a resonance converter,

FIG. 3 shows an exemplary embodiment of a full bridge of a resonance converter and

FIG. 4 shows an exemplary embodiment of a timing diagram of exemplary switching sequences.

### DETAILED DESCRIPTION OF EXEMPLARY EMBODIMENTS

It should be noted that in the following described exemplary embodiments of the invention apply also for the method and the device.

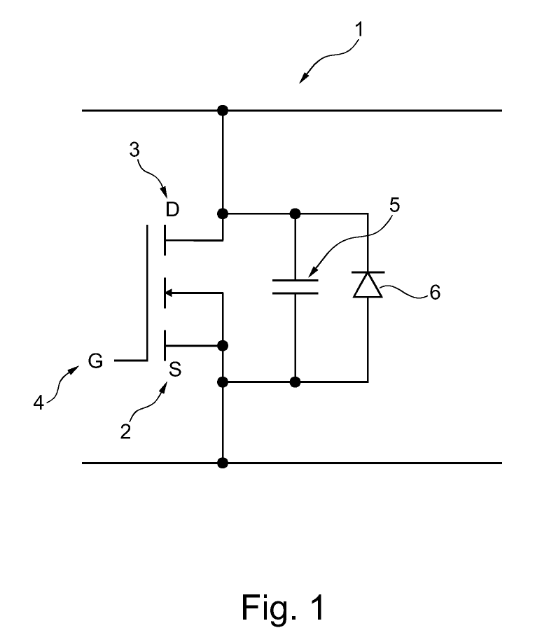

FIG. 1 shows a circuit 1 of a MOSFET comprising parasitic elements. The MOSFET is an n-type MOSFET comprising a source 2, a drain 3 and a gate 4. Between the source 2 and the drain 3 there is a parasitic capacitance 5 present. This parasitic or internal capacitance 5 may also be called “coss capacitance”. The parasitic capacitance or internal capacitance 5 of the MOSFET may be an output capacitance of the MOSFET. Moreover, in parallel to the parasitic capacitance 5 there is a diode 6, which conducts in the direction from the source 2 to the drain 3 and which blocks the current in the direction from the drain 3 to the source 2. The circuit 1 of FIG. 1 shows in a general way the terminals 2, 3, 4 of the MOSFET and also the internal parasitic elements 5, 6 of the MOSFET.

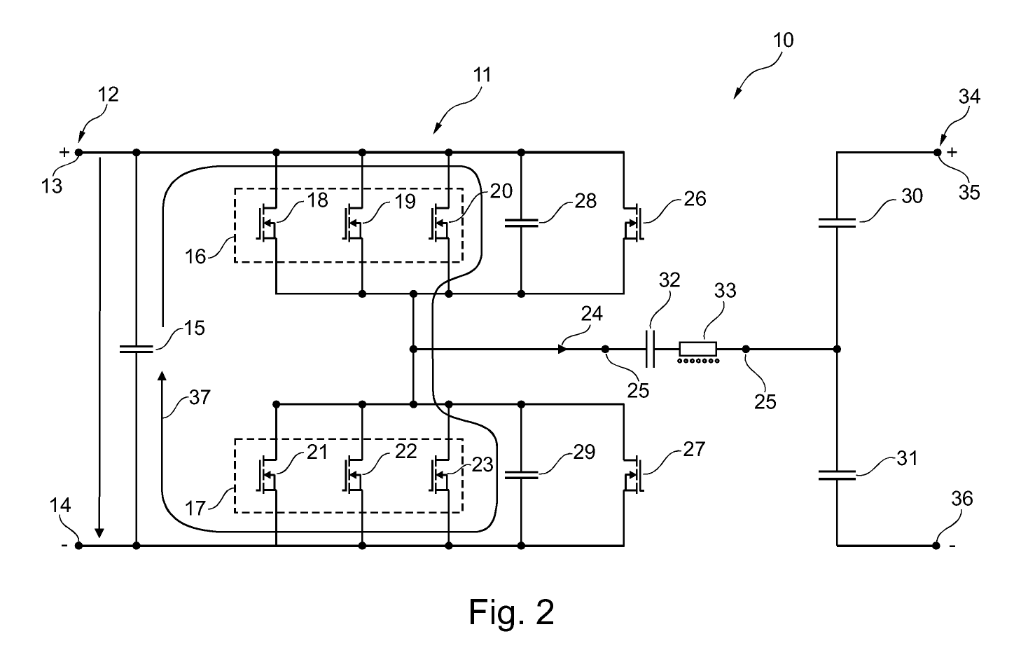

FIG. 2 shows a resonant converter 10 comprising switching device 11 or a half bridge 11. The resonant converter 10 comprises an input connection 12 which may be connected with a DC source, for example a buck converter. The input connection 12 comprises a positive voltage level terminal 13 and a negative voltage level terminal 14. The negative voltage level terminal 14 may be connected to ground or another reference point of the resonant converter 10.

Moreover, in FIG. 2 the resonant converter 10 comprises a rail voltage capacitor 15, which is connected in parallel to the input connection 12. The rail voltage capacitor 15 may have a capacitance of about 270 μF (micro Farad). The half bridge 11 of the resonant converter 10 comprises a first main switch 16 and a second main switch 17. The first main switch 16 and the second main switch 17 are connected in series to each other. Moreover, the series connection of the first main switch 16 and the second main switch 17 are connected in parallel to the rail voltage capacitor 15. The first main switch 16 comprises a plurality of switching elements 18, 19, 20. In addition, the second main switch 17 comprises a plurality of switching elements 21, 22, 23.

In FIG. 2 the switching elements 18, 19, 20, 21, 22, 23 are MOSFETs, respectively. The MOSFETs 18, 19, 20 of the first main switch 16 are connected in parallel to each other, respectively and the MOSFETs 21, 22, 23 of the second main switch 17 are connected in parallel to each other, respectively. It may be foreseen that the MOSFETs of the first main switch and the MOSFETs of the second switch are identical in their electrical and thermal behaviour. This may be the case when they are manufactured within the same semiconducting wafer. The MOSFET 18, 19, 20, 21, 22, 23 may be a MOSFET of 600 V output voltage and may be of the series CoolMOS™ CP comprising a low R_{ds}on, respectively.

In FIG. 2 an exemplary embodiment of a resonant converter 10 comprising a half bridge 11 is shown. However, the resonant converter 10 may comprise more or less MOSFETs within the first main switch 16 and also within the second main switch 17. For example, the first main switch 16 may comprise twelve MOSFETs connected in parallel to each other and the second main switch may comprise as well twelve MOSFETs connected in parallel to each other. The number of MOSFETs within one main switch may be a function of a resonant current Iᵣₑₛ 24. The resonant current 24 may be provided at an output 25 of the resonant inverter 10. Providing a high resonant current 24 may provide a high output power of the resonant inverter 10, for example 50 kW (kilo Watt).

The half bridge 11 is build up in a symmetric way. Thus, the first main switch 16 and the second main switch 17 are identical, meaning having the same number of switching elements 18, 19, 20, 21, 22, 23, wherein the switching elements may provide identical characteristic lines and identical temperature characteristics.

In FIG. 2 a first auxiliary switch 26 is connected in parallel to the first main switch 16. A second auxiliary switch 27 is connected in parallel to the second main switch 17. The first auxiliary switch 26 and the second auxiliary switch 27 are identical or essentially identical. The first auxiliary switch 26 is a MOSFET as well as the second auxiliary switch 27. Both auxiliary switches 26, 27 have the same characteristics, i.e. operation characteristics and temperature characteristics.

In FIG. 2 a first switching capacitor 28 is connected in parallel to the first auxiliary switch 26. In addition, the first switching capacitor 28 is connected in parallel to the first main switch 16. A second switching capacitor 29 is connected in parallel to the second auxiliary switch 27. In addition, the second switching capacitor 29 is connected in parallel to the second main switch 17. The first switching capacitor 28 and the second switching capacitor 29 are identical and may be also called “snubber capacitor”, respectively. The snubber capacitors 28, 29 may stabilize the voltage of the main switches 16, 17, respectively.

In FIG. 2 further capacitances may be present, which may be parasitic capacitances of the MOSFETs, as shown in FIG. 1. These capacitances 5 of each MOSFET may be present also in FIG. 2, but not shown. Moreover, inductances may be present in the resonant converter 10, which are not shown in FIG. 2. These inductances may be caused by wiring between the components 15, 16, 17, 26, 27, 28, 29 of the resonant converter.

Moreover, the resonant converter 10 of FIG. 2 comprises a first bridge capacitor 30 and a second bridge capacitor 31. The first bridge capacitor 30 and the second bridge capacitor 31 are connected in series. The series connection of the capacitors 30, 31 comprises a second input connection 34. The second input connection comprises a positive voltage level terminal 15 and a negative voltage level terminal 36.

The capacitors 30, 31 are connected with the half bridge 11 over the output 25. At the output 25 a resonance capacitor 32 and an inductance 33 are connected in series. The inductance 33 is a part of a transformer, especially the inductance 33 is the primary winding of the transformer. The transformer may transform the output voltage of the resonant converter 10 to a higher voltage for an X-ray tube. The output voltage of the resonant converter 10 at the primary winding of the transformer may have a voltage level of about 400 V to about 1500 V, for example, dependent on the number of switching elements of the first and second main switch 16, 17. The output voltage at the terminal 25 may be transformed into a higher voltage, for example a voltage of 40 kV (kilo Volt) to 150 kV (kilo Volt), depending on the transfer factor of the transformer, for example a factor of about 25 to about 80 may be utilized.

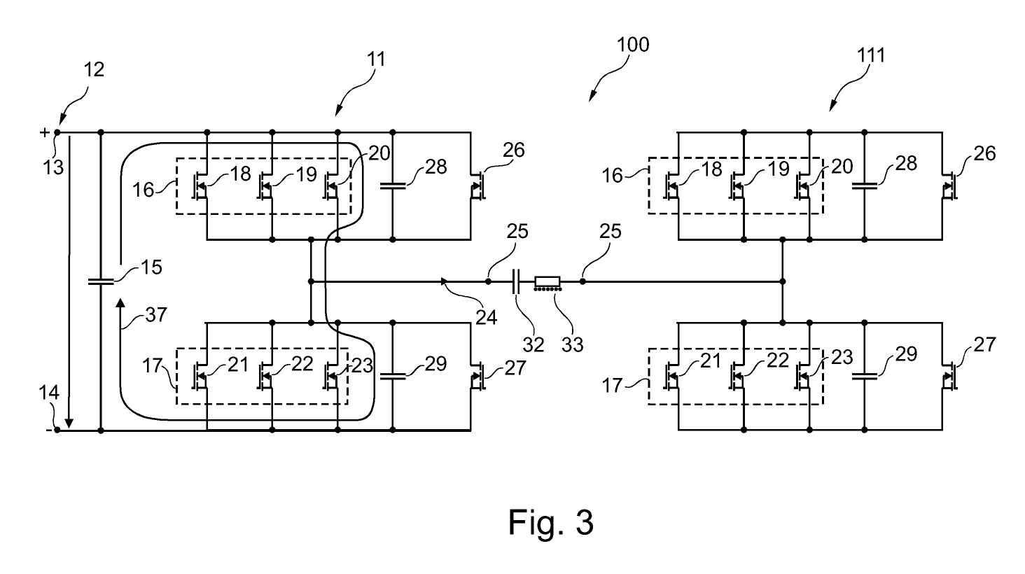

FIG. 3 shows a further exemplary embodiment of a resonant converter 100 comprising a first half bridge 11 and a second half bridge 111. These two half bridges 11, 111 are connected to each other via the output 25 of the resonant converter 100. The first half bridge 11 and the second half bridge 111 are identical. Moreover, the first half bridge 11 of FIG. 3 is identical to the half bridge 11 of FIG. 2. Therefore, the explanations in relation to FIG. 2 are also valid for the circuit of the resonant converter 100 of FIG. 3.

In FIG. 2 and in FIG. 3 an arrow 37 is show, which indicates a path providing oscillations during switching caused by a short circuit current between the first main switch 16 and the second main switch 17. Parasitic oscillations may occur between the output capacitances 5 of a MOSFET when being switched on and the output capacitances 5 of a further MOSFET in another part of the half bridge and parasitic inductances. Moreover, the path 37 is closed via a rail voltage over the rail voltage capacitor 15 and a short circuit may occur. However, the first main switch 16 may be not switched on at the same time when the second main switch 17 is switched on in order to avoid a shortening of half bridge 11. The oscillations may be reduced or substantially eliminated by the provided switching method by utilizing an auxiliary switch.

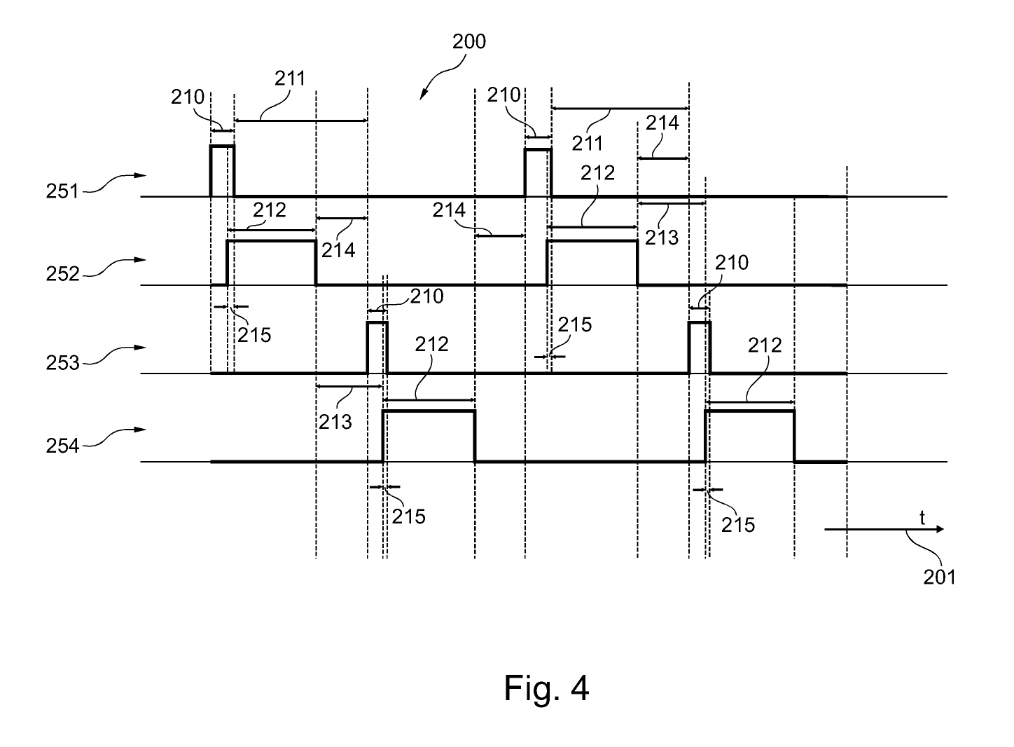

FIG. 4 shows a timing diagram 200 of exemplary switching sequences 251, 252, 253, 254 for different switches of the circuit shown in FIGS. 2 and 3 for one exemplary power level of zero current switching (ZCS). The switching sequences 251, 252, 253, 254 are time dependent, which is indicated by arrow 201. The switching sequences 251, 252, 253, 254 are shown in the same time scale and one below the other in order to compare a plurality of switching points.

A first switching sequence 251 shows the time dependent switching of the first auxiliary switch 26. A second switching sequence 252 shows the time dependent switching of one switching element of the main switch 16, which is for example the MOSFET 18. Since all switching elements of one main switch are identical and are also controlled in an identical way, the switching sequence 252 is also valid for the further MOSFETs 19, 20 of the first main switch 16. A third switching sequence 253 shows the time dependent switching of the second auxiliary switch 27. A fourth switching sequence 254 shows the time dependent switching sequence of one switching element of the second main switch 17, which is for example the MOSFET 21. Since all switching elements of one main switch are identical and are also controlled in an identical way for each main switch, the fourth switching sequence 254 is also valid for the further MOSFETs 22, 23 of the second main switch 17. In FIG. 4 a switched on status for all switches 18, 21, 26, 27 is indicated by a high level voltage and a switched off status is indicated by a low level or zero level voltage.

In FIG. 4 the time intervals of the first auxiliary switch 26 and the second auxiliary switch 27 is identical in respect to their duration of being switched on, which is indicated by time duration 210. However the time intervals of the first auxiliary switch 26 and the second auxiliary switch 27 are timely shifted in relation to each other, which is indicated by time duration 211.

The time interval of the first main switch 16 and the second main switch 17 are identical in respect to their duration of being switched on, which is indicated by time duration 212. However the time intervals of the first main switch 16 and the second main switch 17 are timely shifted in relation to each other, which is indicated by time duration 213

When comparing switching sequence 251, 252, 253 and 254 a dead time 214 is present. The dead time 214 is a time duration when none of the switches 18, 21, 26, 27 is switched on. The dead time may comprise a time duration of about 500 ns (nano seconds).

The first main switch 18 is switched on during a time when the first auxiliary switch 26 is switched on. Thus, the first main switch 18 and the first auxiliary switch 26 have a common time 215 when they are both switched on. This means that the time of being switched on of the first main switch 18 overlaps the time of being switched on of the first auxiliary switch 26.

The second main switch 21 is switched on during a time when the second auxiliary switch 27 is switched on. Thus, the second main switch 21 and the second auxiliary switch 27 have a common time 215 when they are both switched on. This means that the time of being switched on of the second main switch 21 overlaps the time of being switched on of the second auxiliary switch 27.

The overlapping time 215 of the switching sequences 251 and 252 is identical with the overlapping time 215 of the switching sequences 253 and 254.

The timing diagram in FIG. 4 shows that the first auxiliary switch 26 is operated in synchronization with the first main switch 18 and the second auxiliary switch 27 is operated in synchronization with the second main switch 21. Moreover, during the overlapping time 215 the first auxiliary switch 26 discharges the parasitic capacitance 5 of the first main switch 18. In the same manner during the overlapping time 215 the second auxiliary switch discharges the parasitic capacitance 5 of the second main switch 21.

It should be noted that the above-mentioned embodiments illustrate rather than limit the invention and that those skilled in the art will be capable of designing many alternative embodiments without departing from the scope of the invention.

It should be noted, that the invention may be applied especially for resonant power converters in general, for X-ray high voltage generators and for controlled systems with grand sized resolution.

It should be noted that the reference signs in the claims shall not be construed as limiting the scope of the claims.

Further, it should be noted that the term “comprising” does not exclude other elements or steps, and the “a” or “an” does not exclude a plurality. Also elements described in associated with the different embodiments may be combined.

1. Switching device for an x-ray generator for providing a required output power voltage at an output of a resonant power converter,
the switching device comprising:
a main switch,
an auxiliary switch,
wherein the main switch comprises a first internal capacitance,
wherein the auxiliary switch is connected in parallel to the main switch,
wherein the main switch is controllable,
wherein the auxiliary switch controllable,
wherein the auxiliary switch is controllable in dependence of the main switch,
wherein the auxiliary switch is controllable for discharging of the first internal capacitance of the main switch.

2. Switching device according to claim 1,
wherein the auxiliary switch is operable in synchronization with the main switch.

3. Switching device according to claim 1,
wherein the main switch comprises a first MOSFET.

4. Switching device according to claim 1,
wherein the auxiliary switch comprises a second MOSFET

5. Switching device according to claim 1,
wherein a first drain connection of the first MOSFET is connected with a second drain connection of the second MOSFET and a first source connection of the first MOSFET is connected with a second source connection of the second MOSFET.

6. Switching device according to claim 1,
wherein the auxiliary switch is adapted to carry the full current of the main switch.

7. Switching device according to claim 1,
wherein the main switch comprises a first R_{ds}on and the auxiliary switch comprises a second R_{ds}on, wherein the first R_{ds}on is smaller than the second R_{ds}on.

8. Switching device according to claim 1,
wherein the main switch comprises the first internal capacitance and the auxiliary switch comprises a second internal capacitance, wherein the second internal capacitance is smaller than the first internal capacitance.

9. Switching device according to claim 1,
wherein the main switch comprises a n-type-MOSFET.

10. Switching device according to claim 1,
wherein the main switch is connected in parallel to a switching capacitance.

11. Resonant inverter comprising
a switching device of claim 1.

12. Method for controlling a switching device for an x-ray generator in order to provide a required output power voltage at an output of a resonant power converter,
the method comprises
controlling a main switch,
controlling an auxiliary switch,
discharging the main switch by discharging the first internal capacitance of the main switch with the auxiliary switch.

13. Method according to claim 12, wherein
wherein the controlling of the main switch and controlling of the auxiliary switch comprises closing the auxiliary switch in synchronization with closing the main switch.

14. Method according to claim 12, wherein the main switch is switched on during the auxiliary switch is switched on within an overlapping time.

15. Method according to claim 14 wherein the overlapping time has substantially a time duration of about 10 ns to about 100 ns.
